(19) United States
(12) Patent Application Publication
(10) Pub. No.: US 2004/0065271 A1
(43) Pub. Date: Apr. 8, 2004

(54) Pet-used ultraviolet-sterilizing comb

(76) Inventor: Winnie Cheng, Taipei (TW)

Correspondence Address: Winnie Cheng, 235 Chung - Ho, Box 8-24, Taipei, TW

(21) Appl. No.: 10/265,459

(22) Filed: Oct. 7, 2002

(51) Int. Cl. A01K 13/00

(52) U.S. Cl. 119/625

(57) ABSTRACT

A pet-used ultraviolet-sterilizing comb comprises at least one ultraviolet sterilizing lamp and a comb. The comb is formed by a handle and a combing portion. The combing portion has an opening. The opening is installed with a plate. The plate is formed with a plurality of round tapered claws. The claws are arranged along a straight line. A tip of each claw is transparent to ultraviolet ray. The ultraviolet sterilizing lamp is assembled in the combing portion of the comb for generating the sterilizing ultraviolet ray. The ultraviolet ray transmits through the tips of the claws. When combing hairs of a pet, bacteria and parasites on the body of the pet can be removed at the same time by the pet-used ultraviolet-sterilizing comb.

### FIELD OF THE INVENTION

The present invention relates to pet cleaning devices, and particularly to a pet-used ultraviolet-sterilizing comb, wherein in combing hairs of a pet, bacteria and parasites on the body of the pet are removed at the same time by the pet-used ultraviolet-sterilizing comb.

### BACKGROUND OF THE INVENTION

Recently, more and more people breed pets, even the pets have become one member of the breeder's home. Thereby, the problems of prolong the lifetime of the pet and retaining the health of the pets are more and more important for the breeder, and the breeders have pay more attentions to these problems.

Since most of the pets run or jump on the grounds or meadows so that dusts, bacteria, and parasites are adhered on the bodies of the pets. In general, the pets are bathed for removing the dusts, bacteria and parasites.

After bathed, a comb is used to comb the hairs of the pets so that the hairs can be smoothed to prevent the hair from intricacy, and thus the pets feel uneasy.

However, bath only removes the dusts on the hairs of pets, but not remove the bacteria, and parasites in the pet's hairs. As a result, the bacteria and parasites will live at the hairs of the pets, absorbs the bloods of the pets and breeds a great deal of next generations so as to further hurt the bodies of the pets.

### SUMMARY OF THE INVENTION

Accordingly, the primary object of the present invention is to provide a pet-used ultraviolet-sterilizing comb, wherein when combing hairs of a pet, bacteria and parasites on the body of the pet can be removed at the same time by the pet-used ultraviolet-sterilizing comb.

To achieve the object, the present invention provides a pet-used ultraviolet-sterilizing comb comprising at least one ultraviolet sterilizing lamp and a comb; the comb being formed by a handle and a combing portion; the ultraviolet sterilizing lamp is a sterilizing lamp. The combing portion has an opening. The opening is installed with a plate; the plate is formed with a plurality of round tapered claws; the claws are arranged along a straight line. A tip of each claw is transparent to ultraviolet ray. The ultraviolet sterilizing lamp is assembled in the combing portion of the comb for generating the sterilizing ultraviolet ray. The ultraviolet ray transmits through the tips of the claws.

The various objects and advantages of the present invention will be more readily understood from the following detailed description when read in conjunction with the appended drawing.

### BRIEF DESCRIPTION OF THE DRAWINGS

FIG. 1 is a perspective view of the present invention.

FIG. 2 is a schematic perspective view of the present invention, wherein the plate is separated.

FIG. 3 is a cross section view of the present invention, where no plate is formed.

FIG. 4 is a cross section view showing that the present invention is installed with a plate.

FIG. 5 is a schematic view showing that the present invention is used to comb a pet at a portion with short hairs.

FIG. 6 is a schematic view showing that the present invention is used to comba pet at a portion with longer hairs.

### DETAILED DESCRIPTION OF THE PREFERRED EMBODIMENTS

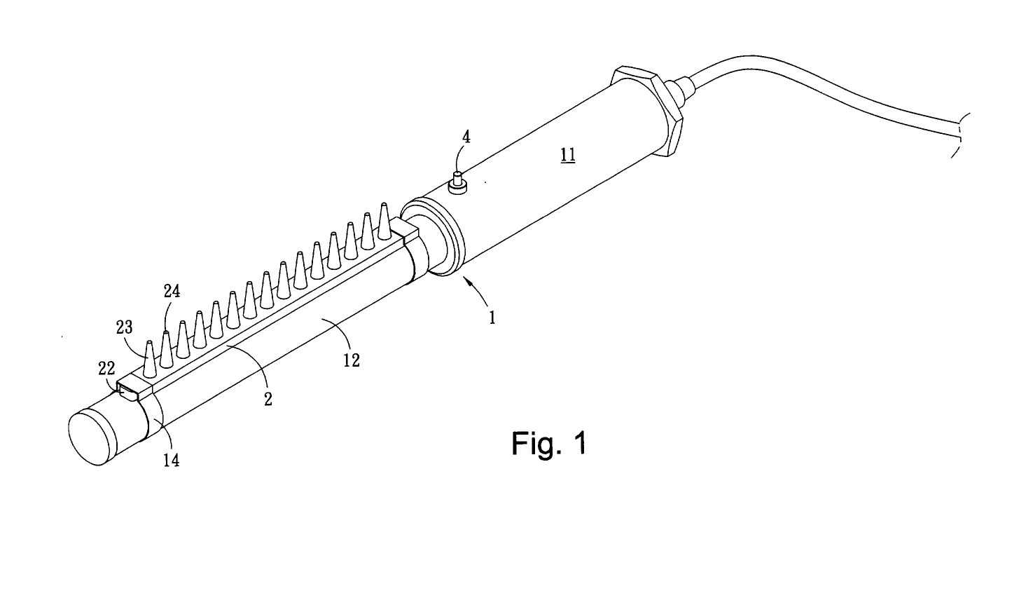

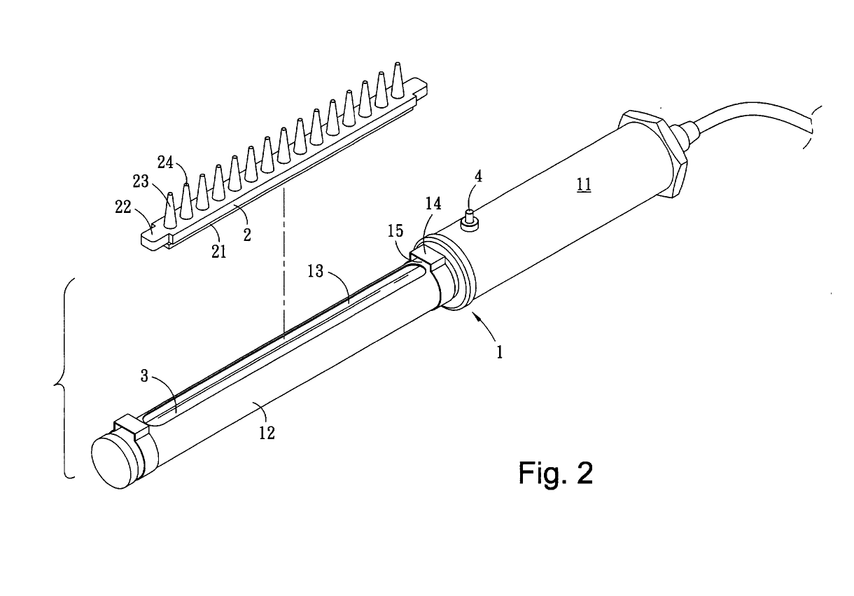

Referring to FIG. 1, the pet-used ultraviolet-sterilizing comb of the present invention is illustrated. The pet-used ultraviolet-sterilizing comb of the present invention includes at least one ultraviolet sterilizing lamp 3, a comb 1, and a switch 4 (referring to FIG. 2).

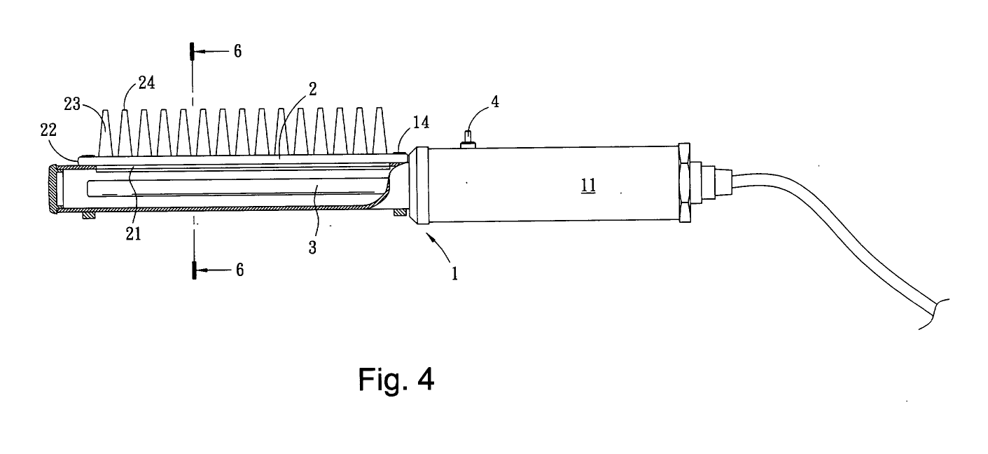

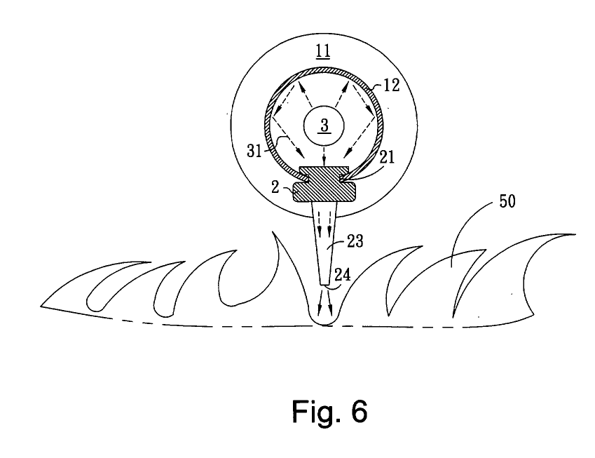

The comb 1 is formed by a handle 11 and a combing portion 12 (referring to FIGS. 1 and 4). The handle 11 is assembled with a timer. The combing portion 12 has an opening 13. Each of the two sides of the opening 13 is formed with a sliding cover 14. Each sliding cover 14 has an via hole 15. The opening 13 is installed with a plate 2. A lower side of the plate 2 is extended with an embedding portion 21. The embedding portion 21 is engaged with the opening 13. A lower side of the plate 2 has ends and each end is extended with a convex portion 22. The combing portions 12 at two sides of the plate 2 are inserted into the via holes 15 of the sliding covers 14 at two sides of the opening 13 so that the plate 2 is engaged to the combing portion 12 of the comb 1. The plate 2 is formed with a plurality of round tapered claws 23. The claws 23 are assembly along a straight line. The tip of each claw 23 is transparent to ultraviolet ray 31 (referring to FIG. 6).

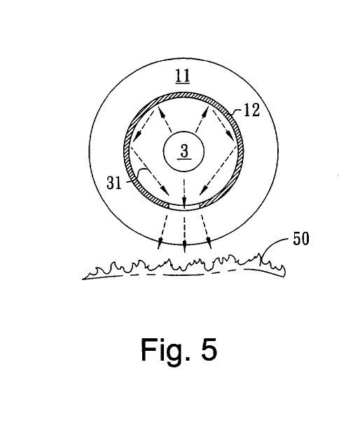

The ultraviolet sterilizing lamp 3 of the present invention is assembled in the combing portion 12 of the comb 1 (referring to FIG. 4) for generating the sterilizing ultraviolet ray 31 (referring to FIG. 5).

The switch 4 is embedded into the handle 11 (referring to FIG. 4) for lighting up the ultraviolet sterilizing lamp 3 and actuating a timer so as to control the lighting-up of the ultraviolet sterilizing lamp 3 for sterilization within a predetermined time period.

By above structure, when cleaning hairs of a pet, the operation of sterilization (including bacteria-killing parasite-killing) and upon the body of the pet is performed at the same time.

In sterilization (referring to FIG. 6), it is only necessary to push the switch 4 on the handle 11 (referring to FIG. 4), the switch 4 will light up the ultraviolet sterilizing lamp 3, and the ultraviolet sterilizing lamp 3 will emit ultraviolet ray 31 (referring to FIG. 6). The ultraviolet ray 31 transmits out from the tips 21 of the claws 23 to radiate upon the body of the pet so as to kill the bacteria and parasites on the body.

When hairs 50 of the pet are too long (referring to FIG. 6), the user holds the handle 11 of the comb 1. The claws 23 of the combing portion 12 are used to move the hairs 50 so that the tips 24 of the combing portion 12 can enter into the root of the pet. Then by the ultraviolet ray 31 radiated from the tips 24 of the combs 23 to radiate upon the hair 5, the bacteria and parasites are killed. Thereby, at the same time, the bacteria and parasites are killed.

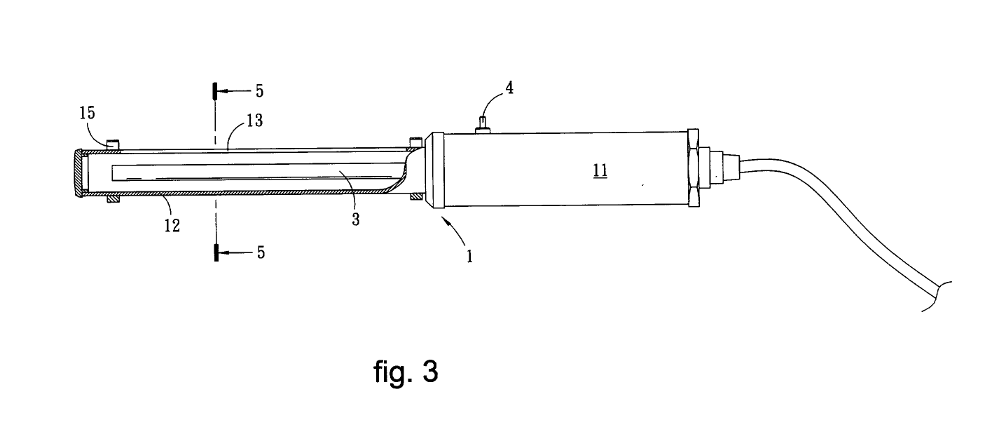

When the hairs 5 of the pet are short (referring to FIG. 5), the sliding covers 14 at two sides of the opening 13 of the combing portion 12 may be moved outwards (referring to FIG. 2) so that the plate 2 is detached easily from the opening 13 of the combing portion 12 (referring to FIG. 3). The ultraviolet ray 31 from the ultraviolet sterilizing lamp 3 radiates out from the opening 13 directly (referring to FIG. 5). The ultraviolet ray 31 from the opening 13 directly radiates upon and kills the bacteria and pets.

Moreover, the tips 24 of the claws 23 may transmit the ultraviolet ray 31 since the plate 2 is made of quartz which can completely transmit the ultraviolet ray 31 so as to retain the ability of sterilization. Other than the tips 24, other portions are coated with anti-ultraviolet ray paints. Thereby, the ultraviolet ray 31 emits only from the tips 24 of the claws 23 to prevent the users body from hurting.

At the time of push switch 4 (referring to FIG. 2), the timer is actuated. At the same time, the timer will not re-count despite that the switch 4 is pressed repeatedly until the timer stops and the power of the ultraviolet sterilizing lamp 3 is interrupted. Then the timer can be recounted by repressing the switch 4. This is used to alert the user the radiating time of the ultraviolet ray 31 so as to avoid the pet to be radiated by the ultraviolet ray 31 through a longer time. Thereby, the timer will not effect the object of the present invention.

Thereby, the ultraviolet sterilizing lamp 3 is connected to a power receptacle through an electric wire. Thereby, the power for lighting the ultraviolet sterilizing lamp is from the receptacle. Moreover, the handle 11 can be assembly with a battery for supplying power to the ultraviolet sterilizing lamp 3.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A pet-used ultraviolet-sterilizing comb for killing bacteria and parasites living on pets; the pet-used ultraviolet-sterilizing comb comprising at least one ultraviolet sterilizing lamp and a comb; the comb being formed by a handle and a combing portion; characterized in that:
the combing portion has an opening; the opening is installed with a plate;
the plate is formed with a plurality of round tapered claws; the claws are arranged along a straight line; a tip of each claw is transparent to ultraviolet ray;
the ultraviolet sterilizing lamp is assembled in the combing portion of the comb for generating the sterilizing ultraviolet ray; the ultraviolet ray transmits through the tips of the claws,
wherein when combing hairs of a pet, bacteria and parasites on the body of the pet can be removed at the same time by the pet-used ultraviolet-sterilizing comb.

2. The pet-used ultraviolet-sterilizing comb as claim in claim 1, wherein the handle is installed with a switch.

3. The pet-used ultraviolet-sterilizing comb as claim in claim 1, wherein the handle is installed with a timer.

4. The pet-used ultraviolet-sterilizing comb as claim in claim 1, wherein each of two sides of the opening is formed with a sliding cover.

5. The pet-used ultraviolet-sterilizing comb as claim in claim 1, wherein a lower side of the plate is extended with an embedding portion.
